(19) United States
(12) Patent Application Publication
(10) Pub. No.: US 2020/0048944 A1
(43) Pub. Date: Feb. 13, 2020

(54) HINGE FOR A DOOR OR WINDOW

(71) Applicant: ROTO FRANK AG, Leinfelden-Echterdingen (DE)

(72) Inventor: BACHATZ Stefan, Voitsberg (AT)

(21) Appl. No.: 16/342,463

(22) PCT Filed: Oct. 19, 2017
(86) PCT No.: PCT/EP2017/076666

§ 371 Date: Apr. 16, 2019

(30) Foreign Application Priority Data
Oct. 19, 2016 (AT) GM50217/2016

(51) Int. Cl. E05D 5/02; E05F 1/12; E05D 7/04

(52) U.S. Cl. CPC E05D 5/02; E05F 1/1253; E05Y 2900/148; E05Y 2900/132; E05D 7/0423

(57) ABSTRACT

A hinge for a door or window, including frame and wing parts. The frame part is connected via a joint to a hinge strap extending normally to the rabbet into a receptacle in the wing part to a penetration depth that corresponds to a multiple of the thickness thereof. A clamping part, displaceable in the insertion direction, fixes the hinge strap in position, is pretensioned towards the rabbet by a spring, is arranged under the receptacle and has a guiding section and a clamping section protruding upwards towards the hinge strap into the receptacle. When inserted, the free end of the hinge strap moves the clamping section counter to the spring force. After the hinge strap has been fully inserted and the wing part has been lowered, the clamping part returns to the starting position and the clamping section bears against a lower end face section of the hinge strap.

### TECHNICAL FIELD

The invention relates to a hinge for a door or window, which has a frame part and a leaf/casement part that are arrangeable in the frame and in the leaf/casement of the door or window, respectively, wherein the frame part has a fastening portion that is connected via a joint to a hinge flap extending substantially normally to the rabbet into a receptacle in the housing of the leaf/casement part, and wherein the penetration depth of the hinge flap in the leaf/casement part corresponds to a multiple of its thickness In the direction normal to the leaf/casement plane of the door or window.

The designations for the frame part and leaf/casement part serve merely to distinguish these two components. It goes without saying for an average person skilled in the art that, depending on the field of application, the frame part can also be mounted on the leaf/casement and, conversely, the leaf/casement part on the frame.

### PRIOR ART

An example of an abovementioned, usually concealed hinge for a door or a window is described in AT 14999 U1. In the hinge disclosed therein, the hinge flap is retained in a receiving part held in the interior of the leaf/casement part. The receiving part is capable of adjustment in all spatial directions. When hanging the door, that part of the hinge flap that projects out of the leaf/casement part has to be connected to a corresponding counterpart on the frame part, or, in the case of a one-piece configuration, the entire arrangement made up of the leaf/casement part and the frame part has to be premounted as a unit either on the frame or on the leaf/casement.

In AT 14782 U1, a similar concealed hinge is described, in which the hinge flap is insertable into a corresponding receptacle in the leaf/casement part. In order to be fixed in position, the hinge flap is retained in the receptacle by in each case two clamping jaws that are settable via separate adjusting screws. Although this arrangement allows easy hanging of a door leaf, it also means additional effort when fixing the hinge flap. Since the user has to tighten the individual clamping jaws, it is not clear, on account of different user behavior, how securely the hinge flap is retained in the receptacle and whether sufficient transfer of the forces that occur and act on the hinge on account of the weight of the door leaf is ensured.

In particular at high leaf/casement weights of for example 140 kg or more, a high force acts, as expected, on the hinge flap. As a result of this load, in practice, given insufficient support in the leaf/casement part, deformations can arise, and the leaf/casement part and thus also the leaf/casement drop.

### PRESENTATION OF THE INVENTION

Therefore, it is an object of the present invention to provide a hinge in which the hinge flap is secured with force transfer that remains constant, In order to prevent deformation and skewing of the hinge flap. In the process, the hinge should be cost-effective to produce and easy to mount, provide protection against disengagement and, during the hanging of the leaf/casement part, also provide the user with perceptible feedback that the final locking position has been reached.

This object is achieved according to the invention in that, in order to fix the position of the hinge flap in the leaf/casement part, a clamping part that is displaceable in the insertion direction of the hinge flap and is preloaded in the direction of the rabbet by means of a spring is provided, said clamping part being arranged beneath the receptacle for the hinge flap and having a guide portion and a clamping portion projecting upwardly from the latter into the receptacle in the direction of the hinge flap, wherein, during the introduction of the hinge flap, the clamping portion cooperates with the free end of the hinge flap and the clamping part is displaceable by said free end counter to the force of its spring, and wherein, after the hinge flap has been fully inserted and the leaf/casement part has been lowered into its locking position, the clamping part returns into its starting position and the clamping portion bears against the hinge flap at a lower end-face portion, with the result that the hinge flap is fixed in position. The spring-loaded clamping part is thus automatically displaced while the leaf/casement is being hung and latches automatically in place once the leaf/casement has been fully hung and lowered. No further screwing on the part of the user is required and the leaf/casement is secured in its position and against disengagement. In this case, the structure is particularly simple, since, instead of a screw mechanism with a clamping wedge, only the spring-loaded clamping part has to be provided. A further advantage is that the latching in place of the clamping part provides clearly audible feedback to the user that the leaf/casement has reached the correct end position.

According to a further feature of the present invention, the guide portion of the clamping part has, on its underside, a groove for receiving a housing protrusion of the leaf/casement part, and a receptacle for the spring is furthermore provided in the guide portion, wherein the spring is supported with one end in the receptacle and with the other end on the housing protrusion of the leaf/casement part. This represents a particularly simple way of realizing the clamping part, since only one component and a spring are required.

A further feature of the present invention is that the rabbet-side free end of the guide portion of the clamping part is in the form of an actuating portion, which is actuable by a user through a corresponding opening in that side of the housing of the leaf/casement part that faces the rabbet, optionally using a tool, for example a screwdriver, with the result that the clamping part is movable from its starting position into a release position. To release the clamping part when the leaf/casement is intended to be taken off for example for repair work, the clamping part can be pushed very easily into its release position from the rabbet side via the opening. In practice, this will be able to be accomplished with the aid of a screwdriver or a specific wrench.

In this case, a further feature of the present invention is that a covering element is insertable into the opening on that side of the housing of the leaf/casement part that faces the rabbet, wherein the covering element has an additional damping portion, which, in the inserted state, comes to lie in the interior of the receptacle for the hinge flap and forms a connection between the hinge flap and the side wall of the receptacle. Thus, in the mounted state of the hinge, the opening is not visible and the hinge flap is also secured in the receptacle on the rabbet-side portion.

According to one possible embodiment of the present invention, the guide portion has a substantially circular cross section, and the clamping part is pivotable, in its release position, about an axis of rotation that extends along the axis of the circular cross section of the guide portion, wherein, after pivoting out of the starting position, the clamping portion is engaged with a corresponding housing edge of the leaf/casement part and as a result the clamping part is secured in its release position. As a rule, a door leaf or window casement has a plurality of hinges, wherein, in order to take off the leaf/casement, the respective clamping part in each hinge has to be brought into its release position. In order to temporarily block the clamping part in its release position in order to take off the leaf/casement, it is very easily possible for the clamping part to be rotated via the actuating portion after being pressed in, with the result that the clamping portion comes to bear against a rear housing edge of the leaf/casement part and is thus secured in the release position.

In an alternative embodiment of the present invention, the clamping part is tillable upward or downward at an angle to its direction of movement via the actuating portion in its release position, with the result that a securing edge is able to be brought into engagement, at the clamping part with a corresponding stop edge in the housing of the leaf/casement part, such that the clamping part is secured in its release position. In this variant, in order to release the hinge flap, the actuating portion is not rotated after the clamping part has been pressed in, but rather raised or lowered slightly, with the result that the guide portion cooperates by way of a corresponding securing edge with a stop edge in the housing and thus retains the clamping part in its release position. The means for securing in the release position can be configured such that, when the hinge flap is inserted again during the refitting of the leaf/casement, they are released automatically and the clamping part returns into its starting position again.

### BRIEF DESCRIPTION OF THE DRAWINGS

The invention will now be described in more detail with reference to the accompanying figures, in which

FIG. 1 shows a sectional view through one possible embodiment of a hinge according to the invention before the hinge flap is introduced into the receptacle in the leaf/casement part,

FIG. 2 shows the hinge from FIG. 1 in an intermediate position during the introduction of the hinge flap into the receptacle in the leaf/casement part, but before the leaf/casement part is lowered into its locking position,

FIG. 3 shows the hinge from FIGS. 1 and 2 in the fully inserted and locked position,

FIG. 4 shows the hinge with an arranged covering element,

FIG. 5 shows a detail view of the clamping part,

FIG. 6 shows a perspective view of one possible embodiment of the hinge according to the invention with the clamping part in the secured release position,

FIG. 7 shows a rear view of the leaf/casement part from FIG. 6 with the position of the clamping part in the secured release position, and

FIG. 8 and FIG. 9 each show sectional views of an alternative embodiment of the hinge according to the invention with an alternative means for securing the release position of the clamping part.

### Way(S) OF IMPLEMENTING THE INVENTION

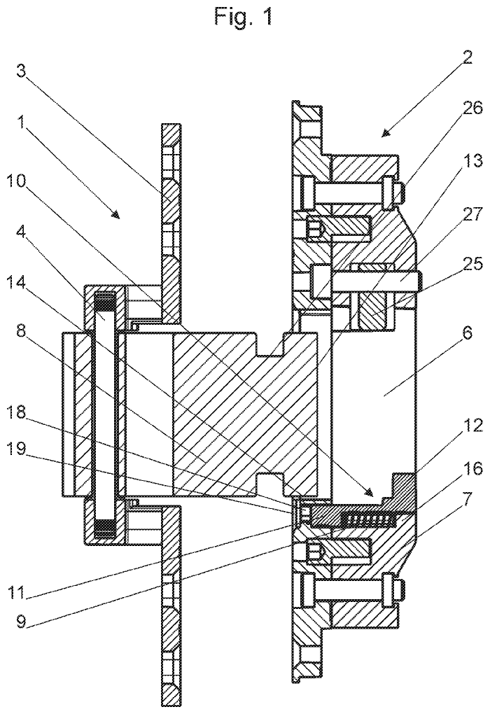

FIGS. 1 to 3 illustrate a hinge according to the invention, which has a frame part 1 and a leaf/casement part 2. The frame part 1 comprises a fastening portion 3, which is connected via a joint 4 to a hinge flap 8. The leaf/casement part 2 comprises a housing 7, which, as in the exemplary embodiment shown, can be embodied in multiple parts and can also have different adjusting devices for the fine adjustment of the hinge. Located in the housing 7. on the side that faces the rabbet 5, is a receptacle 6 for the hinge flap 8. Arranged beneath this receptacle 6 is a clamping part 10 consisting of a guide portion 11 and a clamping portion 12, wherein the clamping part 10 is displaceable counter to the force of a spring 9 in the insertion direction of the hinge flap 8. The clamping portion 12 of the clamping part 10 in this case projects upward into the receptacle 6 for the hinge flap 8. Located on that side of the housing 7 of the leaf/casement part 2 that faces the rabbet is, furthermore, an opening 19, through which an actuating portion 18 of the clamping part 10 can be reached by a user. Via the actuating portion 18, the clamping part 10 can be displaced into its release position, when the hinge flap 8 needs to be removed from the leaf/casement part. The hinge flap 8 furthermore has a retaining recess 26, into which, following insertion Into the leaf/casement part, a retaining protrusion 25 in the leaf/casement part engages while the leaf/casement is being lowered. The retaining protrusion 25 can be displaced via an adjusting screw 27 in the insertion direction of the hinge flap 8 in order to adjust the width of the rabbet 5.

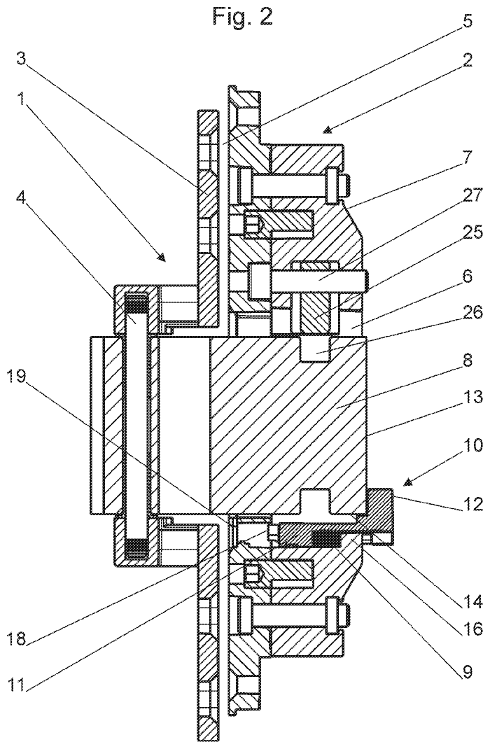

In FIG. 2, the hinge from FIG. 1 is illustrated in a position in which the hinge flap 8 is just being inserted into the receptacle 6 in the leaf/casement part 2. In the process, the free end 13 of the hinge flap 8 presses the clamping portion 12 and thus the entire clamping part 10 backward counter to the force of the spring 9. The hinge flap 8 is inserted until, as a result of the leaf/casement being lowered, the retaining protrusion 25 can engage in the corresponding retaining recess 26 in the hinge flap 8.

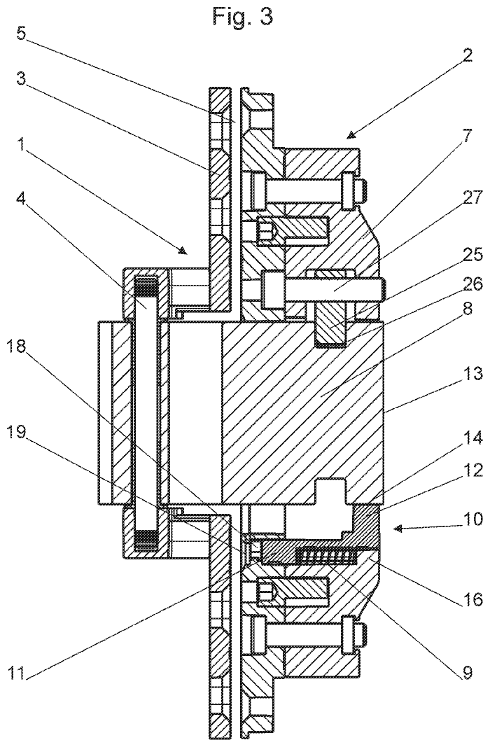

After the leaf/casement part has been lowered, the hinge reaches the position according to FIG. 3, wherein the clamping part 10 returns into its starting position again on account of the force of the spring 9 and the clamping portion 12 now comes to bear against a lower end-face portion 14 of the hinge flap 8. The clearly audible snapping-in of the clamping part 10 signals to the user that the hinge flap 8 has reached its intended end position and is secured within the leaf/casement part 2.

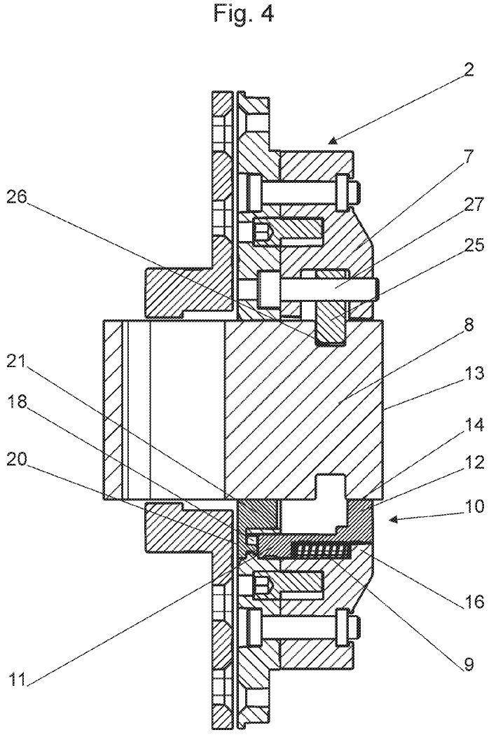

Finally, as illustrated in FIG. 4, a covering element 20 can also be inserted into the opening 19 in the leaf/casement part 2 and into the lower region of the receptacle 6, with the result that the openings are concealed and also, as a result of the covering element 20. an additional clamping portion 21 for the hinge flap 8 is provided.

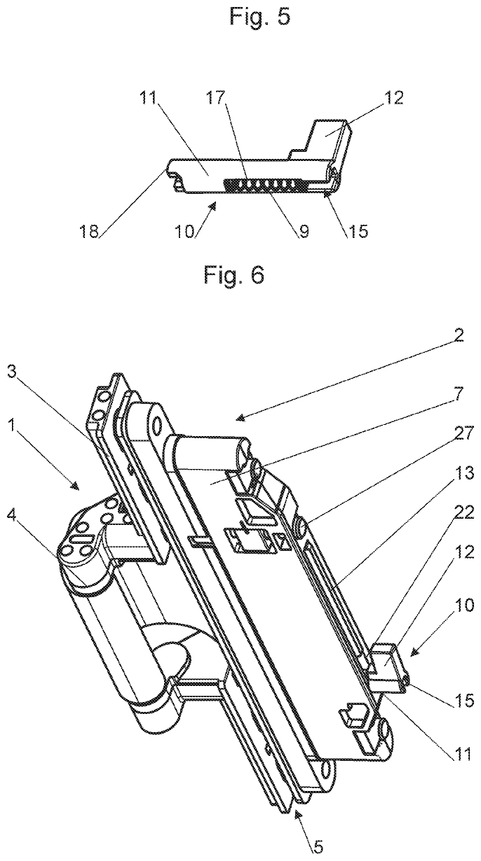

FIG. 5 illustrates one possible embodiment of a clamping part 10. The guide portion 11 has in this case a substantially circular cross section. Provided at the free end of the guide portion 11 is an actuating portion 18. Provided on the underside of the guide portion 11 is a receptacle 17 for mounting the spring 9. Located next to the receptacle 17, at that end of the guide portion 11 that is remote from the rabbet, is a groove 15, in which a housing protrusion 16 (see FIG. 3) is guided. One end of the spring 9 is supported, in the mounted state of the clamping part 10, against the end face of the receptacle 17, while the other end of the spring 9 is supported against the housing protrusion 16.

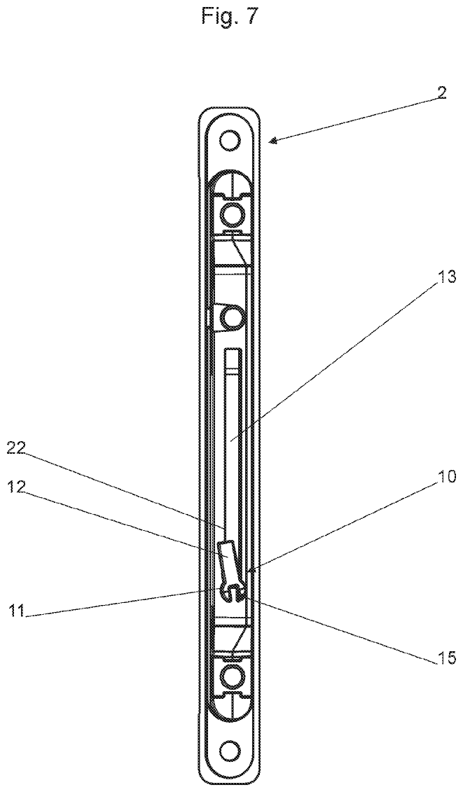

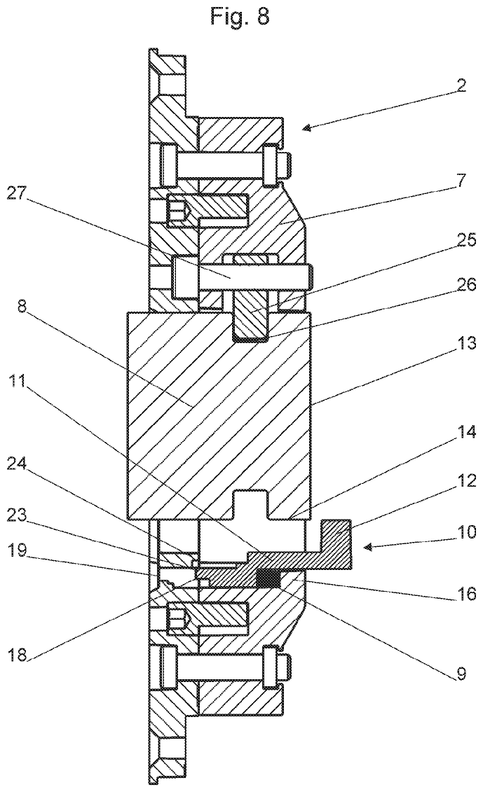

FIGS. 6 and 7 illustrate the release position of the clamping part 10 for one possible embodiment of the invention. To release the clamping part 10, the latter, following the removal of the covering element 20 (see FIG. 4), is displaced backward through the opening 19 (see FIG. 3), counter to the force of the spring 9, by pressure on the actuating portion 18. Once the clamping part 10 has been fully displaced, it is pivoted slightly (see FIG. 7), wherein the axis of rotation corresponds to the axis of the circular cross section of the guide portion 11 of the clamping part 10. As a result, the clamping portion 12 is inclined, now bearing against the leaf/casement part 2 at a housing edge 22 and thus securing the clamping part 10 in its release position.

In FIG. 7, the leaf/casement part 2 is shown from Its rear side, such that the inclined clamping part 10 secured in its release position is readily visible.

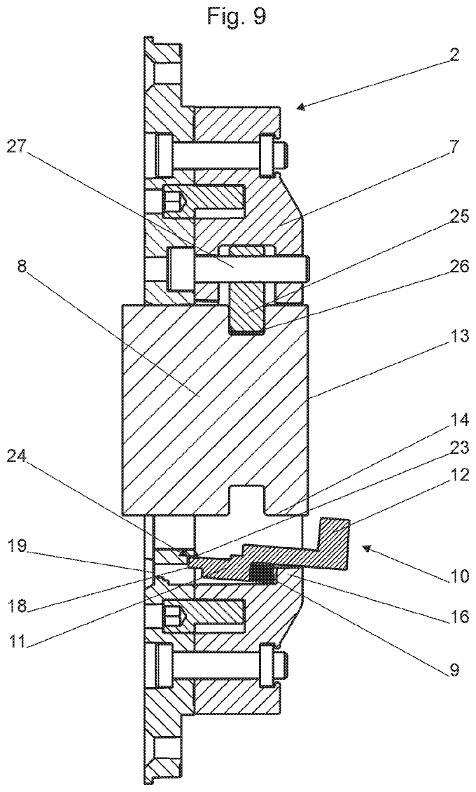

FIGS. 8 and 9 illustrate an alternative embodiment of the clamping part 10. When the hinge flap is released, in this case too, the clamping part 10 is first of all displaced backward by pressing the actuating portion 18 in the leaf/casement part 2 (FIG. 8) and subsequently the clamping part 10 is pivoted slightly upward via the actuating portion 18. As a result, a securing edge 23 on the guide portion 11 of the clamping part 10 comes into engagement with a stop edge 24 in the housing 7 of the leaf/casement part 2, and the clamping part 10 is secured in its release position (FIG. 9).

Both variants of the damping part can be configured such that, when the hinge flap 8 is reinserted, as a result of the free end 13 of the hinge flap 8 abutting the clamping portion 12 of the clamping part 10, the securing of the release position is undone and the clamping part 10 returns by itself into its starting position as soon as the hinge flap 8 has been inserted fully and the leaf/casement part 2 has been lowered.

1-6. (canceled)

7. A hinge for a door or window, which has a frame part and a leaf/casement part that are arrangeable in the frame and in the leaf/casement of the door or window, respectively, wherein the frame part has a fastening portion that is connected via a joint to a hinge flap extending substantially normally to the rabbet into a receptacle in the housing of the leaf/casement part, and wherein the penetration depth of the hinge flap in the leaf/casement part corresponds to a multiple of its thickness in the direction normal to the leaf/casement plane of the door or window, wherein, in order to fix the position of the hinge flap in the leaf/casement part, a damping part that is displaceable in the insertion direction of the hinge flap and is preloaded in the direction of the rabbet by means of a spring is provided, said clamping part being arranged beneath the receptacle for the hinge flap and having a guide portion and a damping portion projecting upwardly from the latter into the receptacle in the direction of the hinge flap, wherein, during the introduction of the hinge flap, the damping portion cooperates with the free end of the hinge flap and the clamping part is displaceable by said free end counter to the force of its spring, and wherein, after the hinge flap has been fully inserted and the leaf/casement part has been lowered into its locking position, in which a retaining protrusion arranged in the leaf/casement part comes to lie in a retaining recess of the hinge flap, the clamping part returns into its starting position and the clamping portion bears against the hinge flap at a lower end-face portion, with the result that the hinge flap is fixed in position.

8. The hinge for a door or window according to claim 7, wherein the guide portion of the clamping part has, on its underside, a groove for receiving a housing protrusion of the leaf/casement part, and in that a receptacle for the spring is furthermore provided in the guide portion, wherein the spring is supported with one end in the receptacle and with the other end on the housing protrusion of the leaf/casement part.

9. The hinge for a door or window according to claim 7, wherein the rabbet-side free end of the guide portion of the clamping part is in the form of an actuating portion, which is actuable by a user through a corresponding opening in that side of the housing of the leaf/casement part that faces the rabbet, optionally using a tool, for example a screwdriver, with the result that the clamping part is movable from its starting position into a release position.

10. The hinge for a door or window according to claim 9, wherein a covering element is insertable into the opening on that side of the housing of the leaf/casement part that faces the rabbet, wherein the covering element has an additional clamping portion, which, in the inserted state, comes to lie in the interior of the receptacle for the hinge flap and forms a connection between the hinge flap and the side wall of the receptacle.

11. The hinge for a door or window according to claim 9, wherein the guide portion has a substantially circular cross section, and in that the clamping part is pivotable, in its release position, about an axis of rotation that extends along the axis of the circular cross section of the guide portion, wherein, after pivoting out of the starting position, the clamping portion is engaged with a corresponding housing edge of the leaf/casement part and as a result the clamping part is secured in its release position.

12. The hinge for a door or window according to claim 9, wherein the clamping part is tiltable upward or downward at an angle to its direction of movement via the actuating portion in its release position, with the result that a securing edge is able to be brought into engagement at the clamping part with a corresponding stop edge in the housing of the leaf/casement part, such that the clamping part is secured in its release position.
